(19) United States
(12) Patent Application Publication
(10) Pub. No.: US 2007/0151833 A1
(43) Pub. Date: Jul. 5, 2007

(54) Multi-direction switch

(75) Inventor: Liang Sun, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/647,030

(22) Filed: Dec. 27, 2006

(30) Foreign Application Priority Data
Dec. 29, 2005 (CN) 200520140609.5

(51) Int. Cl. H01H 13/72

(52) U.S. Cl. 200/5 A

(57) ABSTRACT

A multi-direction switch (100) includes a housing (5) having a cavity, a plurality of stationary contacts (4) fixed in the housing, a metal dome (3) with an arcuate center portion covering some stationary contacts and a circular side portion slightly contacting with some other stationary contacts, a moveable contact (2) defined above the dome, a handle (1) mounted onto the dome for pressing the dome and the moveable contact, and a cover (6) with the top opening (62) attached to housing. The handle extends through the opening for being conveniently operated. A circular gap is defined between the inner side of the opening and the handle for allowing the handle to be moved in different directions. A flexible loop (7) fills in said gap, therefore preventing dust in the environment from entering the housing of the switch.

### BACKGROUND OF THE INVENTION

1. Field of the Invention

The present invention relates to a switch, and in particular to a multi-direction switch employed in portable electronic devices.

2. General Background

Nowdays, multi-direction switches are widely used in various electronic devices such as portable telephones and digital cameras.

The conventional multi-direction switch typically comprises a housing with a cavity, a plurality of stationary contacts fixed in the housing, a dome with an arcuate center portion covering some stationary contacts and a circular side portion slightly contacting with some other stationary contacts, a moveable contact defined above the dome for connecting to or disconnecting from the stationary contacts, a restriction member attached onto the moveable contact, a handle mounted onto and extended through the restriction member for pressing the dome and the moveable contact, and a cover with a top opening attached to housing. The handle extends through the opening for being conveniently operated. A circular gap is defined between the inner side of the opening and the handle for allowing the handle to be actuated in different directions.

In use, when the handle is tilted in different directions, some predetermined stationary contacts are connected. Therefore different signals are transmitted and different connecting functions of the switch are achieved.

However, one problem with this conventional multi-direction switch is that the dust in the environment will probably enter the housing from aforementioned gap and adheres to some contacts, therefore the reliable connection performance of the multi-direction switch can not be ensured.

In view of the above, a new multi-direction switch which overcomes the above-mentioned disadvantages is desired.

### SUMMARY

Accordingly, an object of the present invention is to provide a multi-direction switch that can prevent dust from entering the switch, therefore ensuring reliable connecting performance of the multi-direction switch.

According to a preferred embodiment of the invention, a multi-direction switch comprises a housing having a cavity, a plurality of stationary contacts fixed in the housing, a metal dome with an arcuate center portion covering some stationary contacts and a circular side portion slightly contacting with some other stationary contacts, a moveable contact defined above the dome, a handle mounted onto the dome for pressing the dome and the moveable contact, and a cover with a top opening attached to housing. The handle extends through the opening for being conveniently operated. A circular gap is formed between the inner side of the opening and the handle for allowing the handle to be actuated in different directions. A flexible loop is filled in said gap, therefore preventing dust in the environment from entering the housing of the switch.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of the assembled multi-direction switch in accordance with the preferred embodiment of the present invention;

FIG. 2 is an exploded, isometric view of a multi-direction switch in FIG. 1;

FIG. 3 is an inverted exploded, isometric view of a multi-direction switch in FIG. 1;

FIG. 4 is an isometric view of a handle of the multi-direction switch of FIG. 1; and

FIG. 5 is a cross-sectional of the assembled multi-direction switch of FIG. 1.

### DETAILED DESCRIPTION OF THE PREFERRED EMBODIMENT OF THE INVENTION

Reference will now be made to the drawings to describe the present invention in detail.

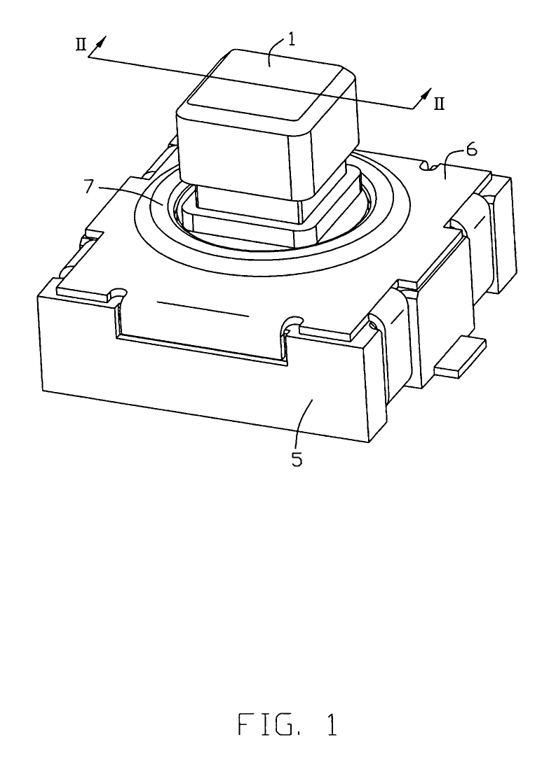

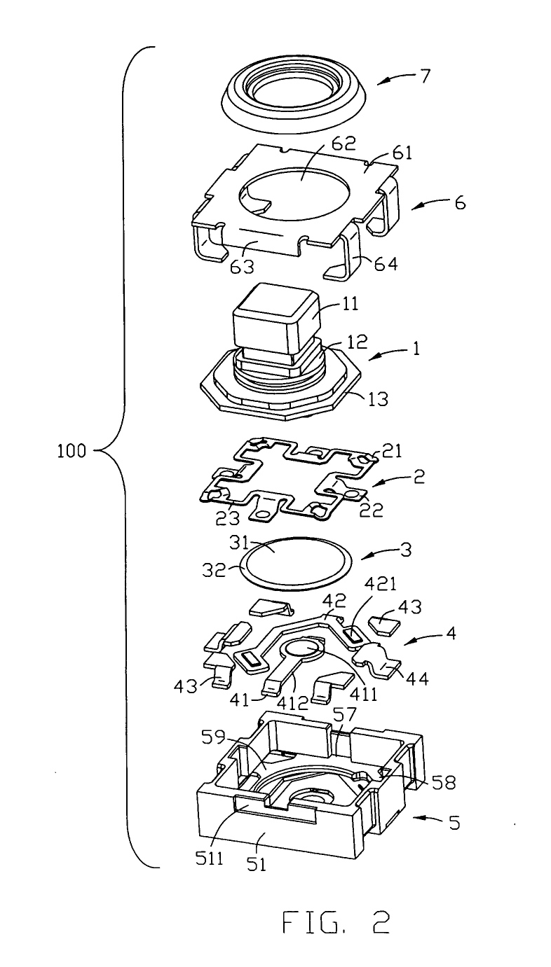

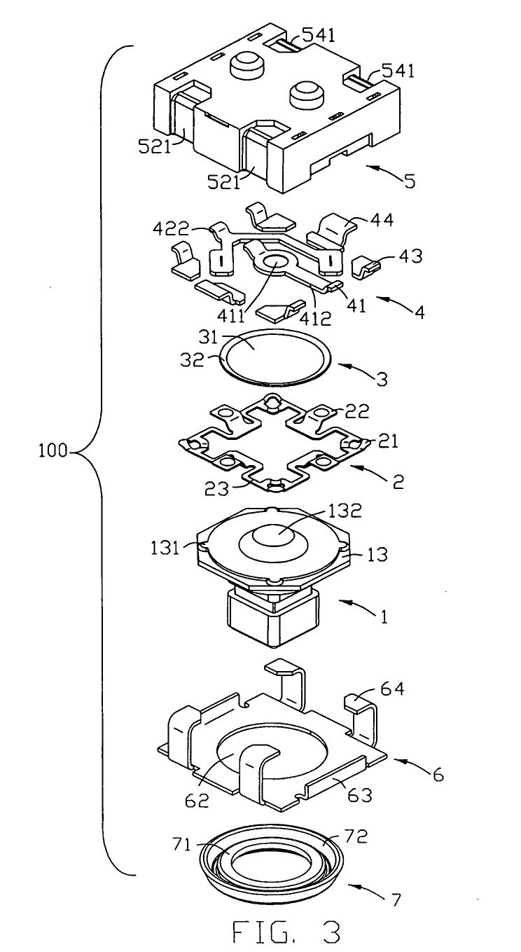

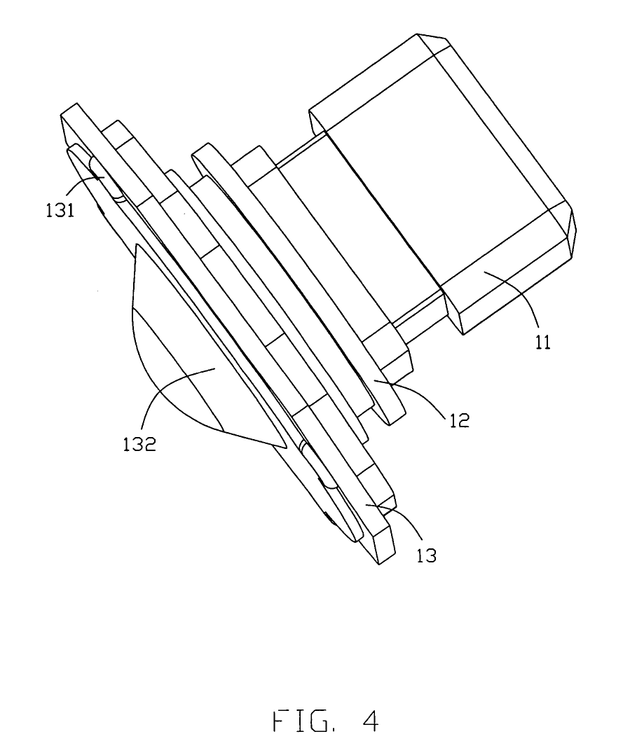

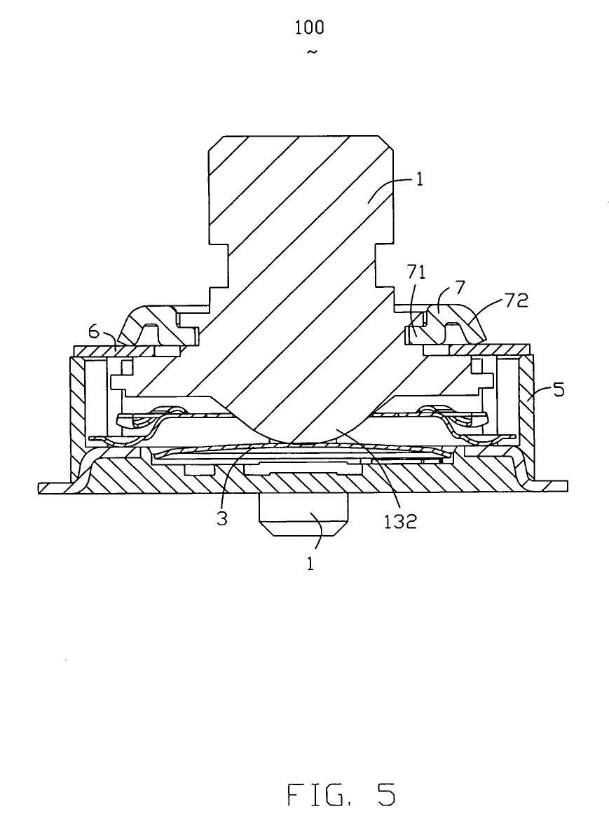

Referring to FIGS. 1-5, a multi-direction switch 100 in accordance with the preferred embodiment of the present invention comprises a housing 5 having a cavity, a plurality of stationary contacts 4 fixed in the housing 5, a metal dome 3 disposed on and connecting with some of the stationary contacts 4, a substantially square moveable contact 2, a handle 1 disposed onto the moveable contact 2, and a cover 6 with a center opening 62 mounted onto the housing 5.

The housing 5 has a substantially rectangular configuration. The housing comprises a bottom surface 59 and a plurality of side surfaces 51 around the bottom surface 59. The bottom surface 59 and side surfaces 51 cooperatively define a cavity. Each side surface comprises recesses 511, 521, 57, 58 in both outside surface and inside surface thereof.

The stationary contacts 4 comprises a first stationary contact 41, a second stationary contact 42, a plurality of third stationary contacts 43 and fourth stationary contacts 43. The first stationary contact 41 comprises a circular pad 411 and an extending arm 412 with a soldering end thereof. The second stationary contact 42 has a semi-loop configuration with two contacting portions 421 at two ends thereof, and the second stationary contact 42 is defined around the circular pad 411 of the first stationary contact 41. The third stationary contacts 43 are defined at each corner of the bottom surface of the housing 5, respectively. The fourth stationary contacts 44 are defined at two opposite sides of the bottom surface of the housing 5.

The dome 3 is made of elastic metal material and comprises an arcuate center portion 31 and an annular side portion 32.

The moveable contact 2 has a substantially frame configuration with four connecting bars and a center opening thereamong. The connecting bars define four first contacting portions 21 at each end thereof and four second contacting portions 22 at the middles thereof. The second contacting portions 22 bend slightly downwardly from the connecting bars and are not coplanar with the first contacting portions 21.

The handle 1 comprises a lower pressing portion 13 for engaging with the moveable contact 2 and the dome 3, a top operating portion 11, and a connecting portion 12 for connecting said pressing portion 13 and the operating member 11. The connecting portion 12 comprises a plurality of steps with different dimensions, and the pressing portion 13 comprises a plurality of first pressing portions 131 for pressing the moveable contact 2 at the peripheral of the lower surface thereof and a cone-shaped second pressing portion 132 at the center of the low surface thereof for pressing the dome 3.

The cover 6 comprises a top plate 61 with a center opening 62 and a plurality of latches 63, 64 extending downwardly from the top plate 61.

In assembly, the stationary contacts 4 are embedded in the bottom surface of the housing 5. The circular pad 411 of the first stationary contact 41 is defined at the center of the bottom surface, and the extending arm 412 extends to one side of the bottom surface. The second stationary contact 42 is defined around the first stationary contact 41, and the second stationary contact 42 defines a lead 422 at the middle thereof extending to the opposite side of the bottom surface 59. The third stationary contacts 43 are defined at corresponding corners of the bottom surfaces, and the fourth stationary contacts 44 are defined at another two opposite sides of the bottom surfaces 59. Then the dome 3 is disposed onto the stationary contacts 4. The side portion 32 contacts with the contacting portions 421 of the second stationary contact 42, and the arcuate center portion 31 covers the circular pad 411 of the first stationary contact 41. The moveable contact 2 is subsequently disposed onto the dome 3, and the dome 3 defines an insulative film thereon for preventing the dome 3 from electrical connecting with the moveable contact 2. The second contacting portions 22 are received in the recesses 58 of the inside surface of the housing 5 for connecting with corresponding fourth stationary contacts 44 in the bottom surface. The first contacting portions 21 are aligned with the third stationary contact 43 and are separated from the third stationary contact 43 before being pressed. The handle 1 is then disposed in the housing, and the cone-shaped second pressing portion 132 is slightly attached on the dome 3. The cover 6 covers the housing 5, with the operating portion 11 of the handle extending through the center opening 62 of the cover. The latches 63, 64 engage with corresponding recesses 511, 521 in the outside surface of the housing, therefore the cover 6 is tightly attached to the housing 5.

A circular gap is formed between the circular side of the center opening 62 and the operating portion 11 of the handle 1, and a circular flexible loop 7 is filled in the gap. The flexible loop 7 has an inner filling portion 71 and an outer covering portion 72 connected with the filling portion 71, and a circular gap is formed between the said two portions. The flexible loop 7 is preferably made of rubber material. Because the loop 7 is flexible, the handle 1 can also be actuated in all directions to achieve different connection. Also because the filling portion 71 is filled in the gap, dust in the environment will not enter the cavity of the housing 5, therefore reliable connecting performance is achieved.

In use, when the handle 1 is pressed downwardly, the second pressing portion 132 presses the arcuate center portion 31 of the dome 3. The center portion 31 therefore deforms downwardly and contacts with the circular pad 411 of the first stationary contact 41. At this time, the first stationary contact 41 and the second stationary contact 42 are connected via the dome 3. When the handle 1 is pressed downwardly and also tilted in some direction, the first pressing portion 131 is tilted to press some first contacting portion 21 and the second pressing portion 132 presses the center portion 31 of the dome 3 at the same time. Therefore, the first stationary contact 41 connects with the second stationary contact 42, and the third stationary contact 43 connects with the fourth stationary contact 44 at the same time. When the force applied on the handle 1 is released, the connecting between aforementioned stationary contacts is broken. Therefore different connecting function of the switch can be achieved by different operation.

While preferred embodiment in accordance with the present invention has been shown and described, equivalent modifications and changes known to persons skilled in the art according to the spirit of the present invention are considered within the scope of the present invention as defined in the appended claims.

What is claimed is:

1. A multi-direction switch comprising:
a housing comprising a bottom surface and a plurality of side surfaces therearound, said bottom surface and side surfaces cooperatively defining a cavity;
a plurality of stationary contacts embedded in the bottom surface of the housing;
a metal dome received in the cavity and contacting with some of the stationary contacts;
a moveable contact attached onto the metal dome, the moveable contact comprising a plurality of first contacting portions apart from said some stationary contacts and a plurality of second contacting portions contacting with some other stationary contacts;
a handle for pressing the dome and the moveable contact;
a cover attached to the housing, the cover defining an opening at a top surface thereof;
wherein the handle extends through the opening, a gap is formed between the inner side of the opening and the handle, and a flexible loop fills in the gap to prevent dust from entering the cavity of the housing.

2. The multi-direction switch as claimed in claim 1, wherein the loop comprises an inner filling portion and an outer covering portion connected with the filling portion.

3. The multi-direction switch as claimed in claim 2, wherein the filling portion fills in the gap between the inner side of the opening and the handle.

4. The multi-direction switch as claimed in claim 3, wherein the covering portion covers a periphery of the opening of the cover.

5. The multi-direction switch as claimed in claim 4, wherein the loop is made of rubber material.

6. The multi-direction switch as claimed in claim 5, wherein the cover comprises a plurality of latches, and the housing comprises a plurality of recesses in outside surface thereof for engaging with said latches.

7. The multi-direction switch as claimed in claim 1, wherein the stationary contacts comprises separated first stationary contact, second stationary contact, third stationary contact and fourth stationary contact, the dome connects with the second stationary contact and the moveable contact connects with the fourth stationary contact before the handle is operated.

8. A multi-direction switch comprising:
a housing comprising a bottom surface and a plurality of side surfaces therearound, said bottom surface and side surfaces cooperatively defining a cavity;
a plurality of stationary contacts embedded in the bottom surface of the housing;
an electric dome received in the cavity and contacting with some of the stationary contacts;
a handle defined above the dome;
a cover attached to the housing, the cover defining an opening at a top surface thereof;
wherein the handle extends through said opening, a gap is formed between the inner side of the opening and the handle, and a flexible loop fills in the gap to prevent dust from entering the cavity of the housing.

9. The multi-direction switch as claimed in claim 8, wherein the multi-direction switch further comprises a moveable contact between the dome and the handle.

10. The multi-direction switch as claimed in claim 9, wherein the loop comprises an inner filling portion and an outer covering portion connected with the filling portion.

11. The multi-direction switch as claimed in claim 10, wherein the filling portion fills in the gap between the inner side of the opening and the handle.

12. The multi-direction switch as claimed in claim 11, wherein the covering portion covers a periphery of the opening of the cover.

13. The multi-direction switch as claimed in claim 12, wherein the loop is made of rubber material.

14. The multi-direction switch as claimed in claim 8, wherein the cover comprises a plurality of latches, and the housing comprises a plurality of recesses in outside surface thereof for engaging with said latches.

15. The multi-direction switch as claimed in claim 9, wherein the stationary contacts comprises separated first stationary contact, second stationary contact, third stationary contact and fourth stationary contact, the dome connects with the second stationary contact and the moveable contact connects with the fourth stationary contact before the handle is operated.

16. A multi-direction switch comprising:
a housing comprising a bottom surface and a plurality of side surfaces therearound, said bottom surface and side surfaces cooperatively defining a cavity;
a plurality of stationary contacts embedded in the bottom surface of the housing;
an electric dome received in the cavity and contacting with some of the stationary contacts;
a handle defined above the dome and moveable in a tilted manner;
a cover positioned upon the housing, the cover defining an opening at a top surface thereof;
wherein the handle extends through said opening, a gap is formed between the inner side of the opening and the handle, and a deformable loop fills in the gap to prevent dust from entering the cavity of the housing; wherein
an outer diameter of said deformable loop is larger than the diameter of the opening.
